(19) United States
(12) Patent Application Publication
(10) Pub. No.: US 2001/0053838 A1
(43) Pub. Date: Dec. 20, 2001

(54) Terminal olefin functionalized macromonomers

(75) Inventors: Roderic P. Quirk, Akron, OH (US); James A. Schwindeman, Lincolnton, NC (US); Robert J. Letchford, Cherryville, NC (US); John Francis Engel, Belmont, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: FMC Corporation

(21) Appl. No.: 09/812,344

(22) Filed: Mar. 20, 2001

Related U.S. Application Data
(60) Provisional application No. 60/190,671, filed on Mar. 20, 2000.

(51) Int. Cl. C08F 36/00

(52) U.S. Cl. 526/335

(57) ABSTRACT

Polymer macromonomers with terminal olefin functionality are prepared by dehydration of polymers with terminal hydroxyl and/or amine functionality. The polymers with terminal hydroxyl and/or amine functionality can be prepared with protected hydroxyl and amine functional organolithium initiators.

### CROSS-REFERENCE TO RELATED APPLICATIONS

This application is related to copending and commonly owned provisional application Serial No. 60/190,671, filed Mar. 30, 2000, and claims the benefit of its priority date under 35 USC 119(e).

### FIELD OF THE INVENTION

The present invention is directed to polymer macromonomers with terminal olefin groups and processes for making the same.

### BACKGROUND OF THE INVENTION

Macromonomers are linear macromolecules carrying some polymerizable functional group at their chain end. Often referred to as “macromers,” these macromolecular monomers can copolymerize with other monomers via a variety of mechanisms to form comb-type graft copolymers, for example, as shown below in reaction scheme (1):

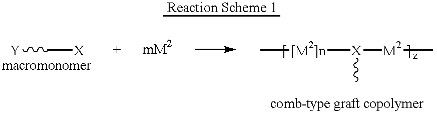

This is in contrast to telechelic polymers, which undergo step-growth type chain extension reactions with other monomers to form linear macromolecules, not branched structures. The functional group at the chain end of a macromonomer is typically a vinyl group or a heterocyclic ring such as an oxirane (epoxide) functionality.

As an example, Milkovich reported the synthesis of a methacryloyl-terminated polystyrene in R. Milkovich, in Anionic Polymerization. Kinetics and Mechanism, J. E. McGrath, Ed., ACS Symposium Ser. No. 166, American Chemical Society, Washington, D.C., 1981, p. 41. However, because poly(styryl)lithium is too reactive for direct reaction with methacryloyl chloride (vinyl addition competes with acylation), the reactivity of the chain end was attenuated by first end capping with ethylene oxide to form the corresponding lithium alkoxide. The polymeric alkoxide was then reacted with methacryloyl chloride to form the methacrylate-functionalized macromonomer. The reaction is illustrated below in Reaction Scheme (2):

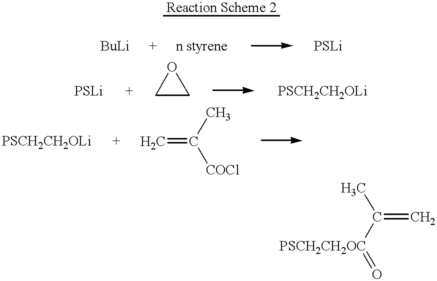

Macromonomers can also be synthesized via the direct reaction of polymeric organolithium compounds with unsaturated alkyl halides. See reaction scheme (3) below:

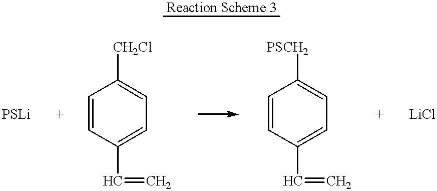

This reaction is complicated, however, by side reactions such as lithium halogen exchange (Reaction Scheme 3A), coupling reactions to form dimeric species (Reaction Schemes 3B, 3C) and elimination reactions when a hydrogen is located in a vicinal position relative to the halogen.

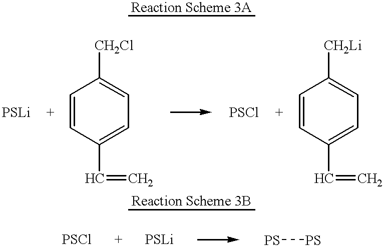

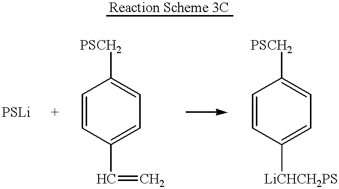

To improve yields, tetrahydrofuran (THF) can be added and the reaction conducted at −78° C. However, THF is known to affect polymer the microstructure. In addition, running the reactions under such extreme temperature conditions can be costly and impractical for commercial scale-up.

Other techniques for synthesizing macromonomers have also been proposed. See discussion at pages H. L. Hsieh and R. P. Quirk, Anionic Polymerization, Marcel Dekker, Inc., 1996, pages 291-300. While these and other process can be useful, there can be problems associated with the same. For example, often reaction efficiencies and yields are poor. Microstructure modifiers, low processing temperatures and other factors may improve yields but can have other effects, which may not be suitable for a particular application.

### SUMMARY OF THE INVENTION

The present invention is directed to polymer macromonomers with terminal olefin groups and processes for making the same. These macromonomers can be prepared by dehydration of polymers with terminal hydroxyl groups. Alternatively the macromonomers can be prepared by elimination of terminal amine based functional groups. The polymers with terminal hydroxyl and/or amine functionality can be prepared using protected hydroxyl and/or amine functional organolithium initiators.

Generally the macromonomers of the invention have the structure:

H₂C═CH—Z—(Q)_{y}—poly

wherein:

Z is a C3 to C18 linear, branched or cyclic alkylene radical, optionally containing aryl or substituted aryl groups;

Q is a hydrocarbyl group derived by incorporation of a compound selected from the group consisting of conjugated dienes, alkenylsubstituted aromatic compounds and mixtures thereof;

y is a number greater than 0 to about 5; and

poly comprises a polymer derived from one or more anionically polymerizable monomers.

A variety of monomers may be anionically polymerized to prepare the macromonomers of the invention, such as of olefin monomers, alkenylsubstituted aromatic monomers, polar monomers and mixtures thereof. For example, ethylene can be polymerized, singly or in combination with a comonomer. Other exemplary monomers include butadiene, isoprene and styrene.

The monomers can be polymerized utilizing a protected functionalized initiator of the formula (R¹R²R³—A)—O—Z—(Q)_{y}—M wherein M is an alkali metal; (A—R¹R²R³) is a protecting group in which A is an element selected from Group IVa of the Periodic Table of the Elements; and R¹, R², and R³ are each independently defined as hydrogen, alkyl, substituted alkyl, aryl, substituted aryl, cycloalkyl and substituted cycloalkyl; and Z, Q, and y have the meanings ascribed above. The resultant living polymer can be terminated using a protonating, capping or coupling agent to provide a polymer having an α-protected hydroxyl functionality. The protecting group is thereafter removed and the liberated hydroxyl functionality is subjected to an elimination step (such as by dehydration) to provide an α-olefin terminated polymer.

In another aspect of the invention, the monomers can be polymerized utilizing a protected functionalized initiator of the formula (R¹R²R³ —A)₂—N—Z—(Q)_{y}—M or

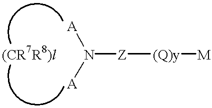

wherein: R⁷ and R⁸ are each independently selected from the group consisting of hydrogen, alkyl, substituted alkyl, aryl, substituted aryl, cycloalkyl, and substituted cycloalkyl; l is an integer from 1 to 7; and M, A, R¹, R², R³, Z, Q, and y are the same described above. The resultant living polymer can be terminating using a protonating, capping or coupling agent to provide a polymer having an α-protected tertiary amine functionality. The protected tertiary amine group is thereafter subjected to appropriate chemistry so that the amine group can be eliminated to provide an α-olefin terminated polymer.

The polymers of the invention can be subjected to various other chemistries as well. For example, the termination step can include a functionalizing step so as to provide a ω-functional group, which may be the same or different as the α-group. The ω-functional group, for example, can include a liberated functional group which can react with one or more comonomers to form polymer segments. Alternatively the liberated functionality can be reacted with an agent to change the functionality thereof and incorporate at least a second reactive olefin end group.

The resultant polymers having a terminal olefin functionality can be used in various applications. For example, the macromonomers of the invention with at least one terminal olefin group can be useful as comonomers in free radical polymerizations or as components in Ziegler/Natta or metallocene polymerization of olefins. Alternatively the terminal olefin functionality can be treated to convert the functionality thereof and the resultant product used in various end uses. For example, the terminal olefin group can be reacted with maleic anhydride to form compounds useful as dispersants for motor oil.

### DETAILED DESCRIPTION OF THE INVENTION

The present invention now will be described more fully hereinafter in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The olefin terminated macromonomers of the invention can be described by the following formula:

H₂C═CH—Z—(Q)_{y}—poly

wherein:

Z is a C3 to C18 linear, branched or cyclic alkylene radical, optionally containing aryl or substituted aryl groups;

Q is a saturated or unsaturated hydrocarbyl group derived by incorporation of a compound selected from the group consisting of conjugated dienes, alkenylsubstituted aromatic compounds and mixtures thereof;

y is a number greater than 0 to about 5; and

poly comprises a polymer derived from one or more anionically polymerizable monomers. The macromonomers can have a molecular weight range of about 1000 to 10,000 but the molecular weight can be higher or lower.

The macromonomers of the invention can include polymer chains derived from any of the types of unsaturated organic compounds that can be polymerized anionically (i.e. in a reaction initiated by an organo-alkali metal). Such compounds include without limitation olefin monomers (including ethylene as well as conjugated dienes), alkenylsubstituted aromatic compounds, polar monomers such as esters, amides, and nitriles of acrylic or methacrylic acid, and the like, as well as mixtures thereof.

To prepare the macromonomers of the present invention, living polymer anions are prepared by anionically polymerizing at least one monomer in an inert solvent at a temperature from −30° C. to 150° C. for a period of at least one hour with a protected functionalized initiator having the formula (I):

(R¹R²R³—A)—O—Z—(Q)_{y}—M (I)

wherein:

M is an alkali metal selected from the group consisting of lithium, sodium and potassium;

(A—R¹R²R³) is a protecting group in which A is an element selected from Group IVa of the Periodic Table of the Elements; and R¹, R², and R³ are each independently defined as hydrogen, alkyl, substituted alkyl, aryl, substituted aryl, cycloalkyl and substituted cycloalkyl; and

Z, Q and y are the same as defined above. Typically 5 to 50 milli-moles of initiator is used per mole of monomer.

In another aspect of the invention the functionalized initiator can include a protected tertiary amine functional group, such as initiators having the following formulas (II) or (III):

(R¹R²R³—A)₂—N—Z—(Q)_{y}—M (II)

or

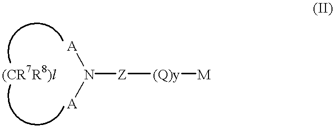

wherein: R⁷ and R⁸ are each independently selected from the group consisting of hydrogen, alkyl, substituted alkyl, aryl, substituted aryl, cycloalkyl, and substituted cycloalkyl; l is an integer from 1 to 7; and M, A, R¹, R², R³, Z, Q, and y are the same described above.

As used herein, the term “alkyl” refers to straight chain and branched C1-C15 alkyl. The term “substituted alkyl” refers to C1-C15 alkyl substituted with one or more lower C1-C10 alkyl, lower alkylthio, or lower dialkylamino. The term “cycloalkyl” refers to C5-C12 cycloalkyl. The term “substituted cycloalkyl” refers to C5-C12 cycloalkyl substituted with one or more lower C1-C10 alkyl, lower alkylthio, or lower dialkylamino. The term “aryl” refers to C5-C25 aryl having one or more aromatic rings, each of 5 or 6 carbon atoms. Multiple aryl rings may be fused, as in naphthyl or unfused, as in biphenyl. The term “substituted aryl” refers to C5-C25 aryl substituted with one or more lower C1-C10 alkyl, lower alkylthio, or lower dialkylamino. Exemplary aryl and substituted aryl groups include, for example, phenyl, benzyl, and the like.

Examples of suitable conjugated diene monomers include, but are not limited to, 1,3-butadiene, isoprene, 2,3-dimethyl-1,3-butadiene, 1,3-pentadiene, myrcene, 2-methyl-3-ethyl-1,3-butadiene, 2-methyl-3-ethyl-1,3-pentadiene, 1,3-hexadiene, 2-methyl-1,3-hexadiene, 1,3-heptadiene, 3-methyl-1,3-heptadiene, 1,3-octadiene, 3-butyl-1,3-octadiene, 3,4-dimethyl-1,3-hexadiene, 3-n-propyl-1,3-pentadiene, 4,5-diethyl-1,3-octadiene, 2,4-diethyl-1,3-butadiene, 2,3-di-n-propyl-1,3-butadiene, 2-methyl-3-isopropyl-1,3-butadiene, and the like and mixtures thereof with one another and with other monomers.

Examples of polymerizable alkenylsubstituted aromatic compounds include, but are not limited to, styrene, alpha-methylstyrene, vinyltoluene, 2-vinylpyridine, 4-vinylpyridine, 1-vinylnaphthalene, 2-vinylnaphthalene, 1-alpha-methylvinylnaphthalene, 2-alpha-methylvinylnaphthalene, 1,2-diphenyl-4-methyl-1-hexene, and the like and mixtures of these, as well as alkyl, cycloalkyl, aryl, alkylaryl and arylalkyl derivatives thereof in which the total number of carbon atoms in the combined hydrocarbon constituents is generally not greater than 18. Examples of these latter compounds include 3-methylstyrene, 3,5-diethylstyrene, 4-tert-butylstyrene, 2-ethyl-4-benzylstyrene, 4-phenylstyrene, 4-p-tolylstyrene, 2,4-divinyltoluene and 4,5-dimethyl-1-vinylnaphthalene. U.S. Pat. No. 3,377,404, incorporated herein by reference in its entirety, discloses suitable additional alkenylsubstituted aromatic compounds.

The monomers may be polymerized alone, or in admixture other monomers to form random copolymers, or by charging the monomers to a reaction mixture sequentially to form block copolymers.

Protected functionalized initiators useful in the invention can be prepared in accordance with known procedures. Reference is made, for example, to U.S. Pat. Nos. 5,621,149; 5,565,526; 5,190,547; 6,020,430; 5,496,940; and 5,527,753. The protected functional initiators include omega-(tert-alkoxy)-1-alkyllithiums; omega-(tert-alkoxy)-1-alkyllithiums chain extended with conjugated alkadiene hydrocarbons, alkenylsubstituted aromatic hydrocarbons and mixtures thereof; omega-(tert-butyldimethylsilyloxy)-1-alkyllithiums; omega-(tert-butyldimethylsilyloxy)-1-alkyllithiums chain extended with conjugated alkadiene hydrocarbons, alkenylsubstituted aromatic hydrocarbons and mixtures thereof; omega-(dialkylamino)-1-alkyllithiums; omega-(dialkylamino)-1-alkyllithiums chain-extended with conjugated alkadiene hydrocarbons, alkenylsubstituted aromatic hydrocarbons, and mixtures thereof; omega-(bis-tert-alkylsilylamino)alkyllithiums; omega-(bis-tert-alkylsilylamino)alkyllithiums chain extended with conjugated alkadiene hydrocarbons, alkenylsubstituted aromatic hydrocarbons, and mixtures thereof; and the like and mixtures thereof.

Examples of protected functionalized organolithium initiators include, but are not limited to, tert-alkoxy-alkyllithiums such as 3-(1,1-dimethylethoxy)-1-propyllithium and its more hydrocarbon-soluble isoprene chain-extended oligomeric analog (y=2 in formula (I) above), 3-(tert-butyldimethylsilyloxy)-1-propyllithium (y=0), and mixtures thereof. Further examples of protected functionalized initiators that may be employed in this invention include, but are not limited to, 3-(1,1-dimethylethoxy)-1-propyllithium, 3-(1,1-dimethylethoxy)-2-methyl-1-propyllithium, 3-(1,1-dimethylethoxy)-2,2-dimethyl-1-propyllithium, 4-(1,1-dimethylethoxy)-1-butyllithium, 5-(1,1-dimethylethoxy)-1-pentyllithium, 6-(1,1-dimethylethoxy)-1-hexyllithium, 8-(1,1-dimethylethoxy)-1-octyllithium, 3-(1,1-dimethylpropoxy)-1-propyllithium, 3-(1,1-dimethylpropoxy)-2-methyl-1-propyllithium, 3-(1,1-dimethylpropoxy)-2,2-dimethyl-1-propyllithium, 4-(1,1-dimethylpropoxy)-1-butyllithium, 5-(1,1-dimethylpropoxy)-1-pentyllithium, 6-(1,1-dimethylpropoxy)-1-hexyllithium, 8-(1,1-dimethylpropoxy)-1-octyllithium, 3-(t-butyldimethylsilyloxy)-1-propyllithium, 3-(t-butyldimethylsilyloxy)-2-methyl-1-propyllithium, 3-(t-butyldimethylsilyloxy)-2,2-dimethyl-1-propyllithium, 4-(t-butyldimethylsilyloxy)-1-butyllithium, 5-(t-butyldimethylsilyloxy)-1-pentyllithium, 6-(t-butyldimethylsilyloxy)-1-hexyllithium, 8-(t-butyldimethylsilyloxy)-1-octyllithium and 3-(trimethylsilyloxy)-2,2-dimethyl-1-propyllithium, and their more hydrocarbon soluble conjugated alkadiene or alkenylsubstituted aromatic chain extended oligomeric analogs (y=greater than 0 to about 5 in formula (I) above).

Examples of protected functionalized organolithium initiators (II) and (III) include, but are not limited to, 3-(dimethylamino)-1-propyllithium and its more hydrocarbon-soluble isoprene chain-extended oligomeric analog (y=2) and 3-[di-(tert-butyldimethylsilyl)amino]-1-propyllithium, and mixtures thereof. Further examples of protected functionalized initiators that may be employed in this invention include, but are not limited to, 3-(dimethylamino)-1-propyllithium, 3-(dimethylamino)-2-methyl-1-propyllithium, 3-(dimethylamino)-2,2-dimethyl-1-propyllithium, 4-(dimethylamino)-1-butyllithium, 5-(dimethylamino)-1-pentyllithium, 6-(dimethylamino)-1-hexyllithium, 8-(dimethylamino)-1-propyllithium, 3-(hexamethyleneimino)-1-propyllithium, 4-(hexamethyleneimino)-1-butyllithium, 5-(hexamethyleneimino)-1-pentyllithium, 6-(hexamethyleneimino)-1-hexyllithium, 8-(hexamethyleneimino)-1-octyllithium, and their more hydrocarbon soluble conjugated alkadiene or alkenylsubstituted aromatic chain extended oligomeric analogs (y=greater than 0 to about 5 in formula (II) or (III) above). It is noted that chain extension of the initiators described herein can be accomplished with less than one equivalent of conjugated and/or alkenylsubstituted aromatic compound.

The inert solvent employed during the polymerizations is preferably a non-polar solvent such as a hydrocarbon, since anionic polymerization in the presence of such non-polar solvents is known to produce polyenes with high 1,4-contents from 1,3-dienes. Inert hydrocarbon solvents useful in practicing this invention include, but are not limited to, inert liquid alkanes, cycloalkanes and aromatic solvents such as alkanes and cycloalkanes containing five to ten carbon atoms such as pentane, hexane, cyclohexane, methylcyclohexane, heptane, methylcycloheptane, octane, decane and so forth and aromatic solvents containing six to ten carbon atoms such as benzene, toluene, ethylbenzene, p-xylene, m-xylene, o-xylene, n-propylbenzene, isopropylbenzene, n-butylbenzene, and the like.

Polar solvents (modifiers) can be added to the polymerization reaction to alter the microstructure of the resulting polymer, i.e., increase the proportion of 1,2 (vinyl) microstructure or to promote functionalization or randomization. Examples of polar modifiers include, but are not limited to, diethyl ether, dibutyl ether, tetrahydrofuran, 2-methyltetrahydrofuran, methyl tert-butyl ether, 1,2-dimethoxyethane (glyme), 1,2-diethoxyethane, diazabicyclo[2.2.2]octane, triethylamine, tributylamine, N-methylpiperidine, N-methylpyrrolidine, and N,N,N′,N′-tetramethylethylene diamine (TMEDA). The amount of the polar modifier added depends on the vinyl content desired, the nature of the monomer, the temperature of the polymerization, and the identity of the polar modifier. The polar solvent (modifier) can be added to the reaction medium at the beginning of the polymerization as part of the solvent reaction medium or added during the polymerization.

The polymerization reaction can proceed from initiation to propagation to form a living polymer anion having a terminal protected hydroxyl functionality. The resulting living polymer can be generally represented as follows:

(R¹R²R³—A)—O—Z—(Q)_{y}—poly-M

wherein R¹, R², R³, A, Z, Q, y, poly, and M have the meanings ascribed above.

Alternatively, the resulting living polymer can be generally represented as follows:

(R¹R²R³—A)₂—N—Z—(Q)_{y}—poly-M

or

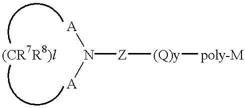

wherein R¹, R², R³, R⁷, R⁸, A, Z, Q, y, l, poly, and M have the meanings ascribed above.

Polymerization is terminated with appropriate reagents so that the polymer is mono-functionally or di-functionally terminated. For example, the mono-protected mono-functional living polymer can be quenched or terminated, for example by addition of a suitable proton donor, such as water, methanol, isopropanol, acetic acid, and the like, to provide a mono-functional polymer.

Alternatively, polymerization can be followed by functionalization of the resultant living anion with a suitable electrophile to provide a mono- or di-protected, di-functional polymer. The di-functional polymer may be telechelic, i.e., contain two functional groups, which are the same, per molecule at the termini of the polymer. The polymer can also be hetero-telechelic, having different functionalities, and/or differently protected functionalities, at opposite ends of the polymer chain.

The functionalizing agents, or electrophiles, can be prepared as described, for example, in International Publication WO 97/16465, the entire disclosure of which is incorporated by reference. See also U.S. Pat. No. 5,910,547. Such functionalizing agents (electrophiles) include those having the following structure:

X—Y—W—(B—R⁴R⁵R⁶)_{K}

wherein:

X is halogen selected from chloride, bromide and iodide;

Y is a C1 to C18 linear, branched or cyclic alkylene radical, optionally containing aryl or substituted aryl groups;

W is oxygen, nitrogen or sulfur;

(B—R⁴R⁵R⁶) is a protecting group in which B is an element selected from Group IVa of the Periodic Table of the Elements; and R⁴, R⁵, and R⁶ are each independently defined as hydrogen, alkyl, substituted alkyl, aryl, substituted aryl, cycloalkyl and substituted cycloalkyl or R⁶ is optionally a —(CR⁷R⁸)ₗ— group linking two B when k is 2, wherein R⁷ and R⁸ are each independently selected from the group consisting of hydrogen, alkyl, substituted alkyl, aryl, substituted aryl, cycloalkyl, and substituted cycloalkyl, and l is an integer from 1 to 7; and

k is 1 when W is oxygen or sulfur and 2 when W is nitrogen. Thus the skilled artisan will appreciate that R⁶ as used herein includes the group

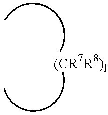

linking two B groups when k is 2.

In addition, the electrophiles can be prepared as described in M. Tokyamo, A. Hirao, S. Nakahama and K. Takenaka, Macromol. Chem. Phys., 197, 3135 (1996); K. Ueda, A. Hirao, and S. Nakahama, Macromolecules, 23, 939 (1990); U.S. Pat. No. 5,496,940; U.S. Pat. No. 5,600,021; U.S. Pat. No. 5,362,699; A. Alexakis, M. Gardette, and S. Colin, Tetrahedron Letters, 29, 1988, 2951; B. Figadere, X. Franck, and A. Cave, Tetrahedron Letters, 34, 1993, 5893; J. Almena, F. Foubelo, and M. Yus, Tetrahedron, 51, 1995, 11883; D. F. Taber and Y. Wang, J. Org. Chem., 58, 1993, 6470; F. D. Toste and I. W. J. Still, Synlett, 1995, 159; and U.S. Pat. No. 5,493,044, the entire disclosure of each of which is also incorporated by reference. The functionalization step can be conducted at temperatures ranging from about −30° C. to about 150° C.

Other compounds useful in functionalizing living polymers include, but are not limited to, alkylene oxides, such as ethylene oxide, propylene oxide, styrene oxide, and oxetane; oxygen; sulfur; carbon dioxide; halogens such as chlorine, bromine and iodine; propargyl halides; alkenylhalosilanes and omega-alkenylarylhalosilanes, such as styrenyldimethyl chlorosilane; sulfonated compounds, such as 1,3-propane sultone; amides, including cyclic amides, such as caprolactam, N-benzylidene trimethylsilylamide, and dimethyl formamide; silicon acetals; 1,5-diazabicyclo[3.1.0]hexane; allyl halides, such as allyl bromide and allyl chloride; methacryloyl chloride; amines, including primary, secondary, tertiary and cyclic amines, such as 3-(dimethylamino)-propyl chloride and N-(benzylidene)trimethylsilylamine; epihalohydrins, such as epichlorohydrin, epibromohydrin, and epiiodohydrin; haloalkyl trialkoxysilanes; and other materials as known in the art to be useful for terminating or end capping polymers. These and other useful functionalizing agents are described, for example, in U.S. Pat. Nos. 3,786,116 and 4,409,357, the entire disclosure of each of which is incorporated herein by reference.

The resulting polymer can be generally represented as follows:

(R¹R²R³—A)—O—Z—(Q)_{y}—poly-FG

wherein FG can be hydrogen or a protected or unprotected functional group, and R¹, R², R³, A, Z, Q, y, and poly have the meanings ascribed above.

Alternatively, the resulting living polymer can be generally represented as follows:

(R¹R²R³—A)₂—N—Z—(Q)_{y}—poly-FG

or

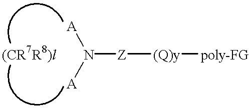

wherein FG, R¹, R², R³, R⁷, R⁸, A, Z, Q, y, l, and poly have the meanings ascribed above.

The resultant polymer having at least one terminal protected hydroxy functional group can then be treated under conditions sufficient to remove the protecting group and liberate the hydroxy functionality.

The polymers may be optionally hydrogenated prior to or after deprotection. Examples of methods to hydrogenate the polymers of this invention are described in Falk, Journal of Polymer Science: Part A-1, vol. 9, 2617-2623 (1971), Falk, Die Angewandte Chemie, 21, 17-23 (1972), U.S. Pat. Nos. 4,970,254, 5,166,277, 5,393,843, 5,496,898, and 5,717,035. The hydrogenation of the functionalized polymer is conducted in situ, or in a suitable solvent, such as hexane, cyclohexane or heptane. This solution is contacted with hydrogen gas in the presence of a catalyst, such as a nickel catalyst. The hydrogenation is typically performed at temperatures from 25° C. to 150° C., with an archetypal hydrogen pressure of 15 psig to 1000 psig. The progress of this hydrogenation can be monitored by InfraRed (IR) spectroscopy or Nuclear Magnetic Resonance (NMR) spectroscopy. The hydrogenation reaction is conducted until at least 90% of the aliphatic unsaturation has been saturated. The hydrogenated functional polymer is then recovered by conventional procedures, such as removal of the catalyst with aqueous acid wash, followed by solvent removal or precipitation of the polymer.

The protecting group can be removed, for example, using acid catalyzed deprotection, such as described in more detail below. One such resulting polymer can be generally represented as follows:

HO—Z—(Q)_{y}—poly-FG

wherein Z, Q, y, poly and FG have the meanings ascribed above.

Deprotection of the α-functional hydroxyl group can be performed using acid catalysis. For example, to remove tert-alkyl-protected groups, the protected polymer is mixed with Amberlyst® 15 ion exchange resin and heated at an elevated temperature, for example 150° C., until deprotection is complete. In addition, tert-alkyl-protected groups can also be removed by reaction of the polymer with trifluoroacetic acid, p-toluenesulfonic acid or trimethylsilyliodide. Additional methods of deprotection of the tert-alkyl protecting groups can be found in T. W. Greene and P. G. M. Wuts, Protective Groups in Organic Synthesis, Second Edition, Wiley, New York, 1991, page 41. The tert-butyldimethylsilyl protecting groups can be removed by treatment of the polymer with acid, such as hydrochloric acid, acetic acid, para-toluenesulfonic acid, or Dowex 50W-X8. Alternatively, a source of fluoride ions, for instance tetra-n-butylammonium fluoride, potassium fluoride and 18-crown-6, or pyridine-hydrofluoric acid complex, can be employed for deprotection of the tert-butyldimethylsilyl protecting groups. Additional methods of deprotection of the tert-butyldimethylsilyl protecting groups can be found in T. W. Greene and P. G. M. Wuts, Protective Groups in Organic Synthesis, Second Edition, Wiley, New York, 1991, pages 80-83. See also U.S. Pat. No. 5,922,810.

The polymer with at least one liberated hydroxyl functionality is thereafter treated under conditions sufficient to eliminate the hydroxyl group and form a terminal olefin group, for example, utilizing acid catalyzed dehydration. The resultant polymer can be generally represented as follows:

H₂C═CH—Z—(Q)_{y}—poly-FG

wherein Z, Q, y, poly and FG have the meanings ascribed above.

Conventional dehydration processes as known in the art can be used. For example, H₂SO₄ and H₃PO₄ may be used as acid dehydration reagents. Metallic oxides may also be used, such as but not limited to Cr₂O₃, TiO₂ and WO₃, as well as sulfides, other metallic salts and zeolites. Still further, the alcohol can be converted to an ester and the ester subjected to pyrolysis. Vapor phase elimination over Al₂O₃ may be used for alcohols that can be evaporated, even high molecular weight alcohols. Many other dehydrating agents may also be used, such as P₂O₅, I₂, ZnCl₂, BF₃-etherate, dimethyl sulfoxide, KHSO₄, anhydrous CuSO₄ and phthalic anhydride, among others. Temperatures can vary, and generally range from about 100° C. up to 300° C., although temperatures outside of this range may also be used. See March, J., “Advanced Organic Chemistry, Reactions, Mechanisms, and Structure,” 4th Edition, John Wiley & Sons, 1992, page 1011, which is incorporated herein by reference. See also Cram, D. & Hammond, G., “Organic Chemistry,” 2nd Edition, McGraw-Hill Book Co, 1959, pages 337-338, which are also incorporated herein by reference.

In an alternative aspect of the invention, the polymer with at least one protected tertiary amine group can be treated under conditions sufficient to modify the amine group and to eliminate the modified amine group to form a terminal olefin group, for example, utilizing acid catalyzed dehydration. For example, the protected tertiary amine group can be quaternized (using known techniques, such as reaction with methyl iodine) and the quaternary amine group eliminated using heat (typically about 125° C. or higher, although again temperatures below this may be used) to form a terminal olefin group. See, for example, March, J., “Advanced Organic Chemistry, Reactions, Mechanisms, and Structure,” 4th Edition, John Wiley & Sons, 1992, pages 914, 919-920, which is incorporated herein by reference. Alternatively, the protected tertiary amine group can be reacted with a peroxide or peracid to form an N-oxide group, which in turn can be eliminated by thermal treatment (for example at 100-150° C., although not limited to this temperature range) to form a terminal olefin group. See March, J., “Advanced Organic Chemistry, Reactions, Mechanisms, and Structure,” 4th Edition, John Wiley & Sons, 1992, pages 1018, which is also incorporated herein by reference.

The resultant polymer can also be generally represented as follows:

H₂C═CH—Z—(Q)_{y}—poly-FG

wherein Z, Q, y, poly and FG have the meanings ascribed above. Conventional elimination processes as known in the art can be used.

In other aspects of the invention in which FG is a protected functional group, the protecting group can also be removed (simultaneously with removal of the protecting group R¹R²R³—A or in a separate deprotection step) to liberate this functionality. The liberated functionality can be further treated to convert the functionality and/or to participate in subsequent polymerization chemistry.

For example, when the living chain end is reacted with a protected functionalized electrophile, the resultant protected functionality can also be deprotected, and the liberated functionality can optionally be reacted with one or more comonomers to polymerize a functional end thereof. Exemplary comonomers include without limitation cyclic ethers, diamines, diisocyanates, polyisocyanates, di-, poly- and cyclic amides, di- and polycarboxylic acids, diols, polyols, anhydrides, and the like and mixtures thereof. For example, functionalized polymers can be further reacted with monofunctional monomers, such as caprolactam, or other lactams, to form a polyamide block polymer segment, or cyclic ethers such ethylene oxide to form polyether blocks; or with difunctional monomers, such as diacids or anhydrides and diamines to form polyamide blocks, or diacids or anhydrides or lactones and diols to form polyester blocks, or diols and polyols with diisocyanates or polyisocyanates to form polyurethane blocks. Polyisocyanates or polyfunctional polyols are examples of polyfunctional monomers.

The functional group may also be reacted with a suitable agent containing a reactive olefin bond, such as a styrenic or acrylic functionality, including but not limited to acryloyl or methacryloyl chloride, which will act to change the nature of the functionality and provide a macromonomer having additional olefin end groups that are capable of polymerizing with other free radically polymerizable monomers.

Such polymers can be generally represented by the formula

H₂C═CH—Z—(Q)_{y}—poly—X

wherein Z, Q, y, and poly have the meanings ascribed above and X represents a polymer segment resulting from the reaction of the liberated functionality with one or more comonomer, or X represents a reactive olefinic bond.

The following table details experimental conditions that will selectively remove one of the protecting groups (more labile) from the polymer, while retaining the other protecting group (more stable). See also U.S. Pat. Nos. 5,922,810 and 5,910,547.

| LABILE | STABLE | CONDITIONS |
|---|---|---|
| t-butyldimethylsilyl | t-butyl | tetrabutylammonium fluoride |
| t-butyldimethylsilyl | t-butyl | 1 N HCl |
| t-butyldimethylsilyl | dialkylamino | tetrabutylammonium fluoride |
| t-butyldimethylsilyl | dialkylamino | 1 N HCl |
| t-butyl | dialkylamino | Amberlyst resin |
| t-amyl | dialkylamino | Amberlyst resin |
| trimethylsilyl | t-butyl | tetrabutylammonium fluoride |
| trimethylsilyl | t-butyl | 1 N HCl |
| trimethylsilyl | dialkylamino | tetrabutylammonium fluoride |
| trimethylsilyl | dialkylamino | 1 N HCl |
| 2,2,5,5-tetramethyl-2,5- | t-butyl | tetrabutylammonium fluoride |
| disila-1-azacyclopentane | | |
| 2,2,5,5-tetramethyl-2,5- | t-butyl | 1 N HCl |
| disila-1-azacyclopentane | | |
| 2,2,5,5-tetramethyl-2,5- | dialkylamino | tetrabutylammonium fluoride |
| disila-1-azacyclopentane | | |
| 2,2,5,5-tetramethyl-2,5- | dialkylamino | 1 N HCl |
| disila-1-azacyclopentane | | |

The present invention will be further illustrated by the following descriptions of various macromonomers which can be prepared in accordance with the present invention.

In one aspect of the invention, polyethylene macromonomers with a terminal olefin group can be prepared by an elimination reaction, such acid catalyzed dehydration of polyethylene which has a terminal hydroxyl group, or a derivative of such. Polyethylene with α-protected hydroxyl functionality can be prepared using a protected hydroxy functional organolithium initiator. For example, initiators of type R—O—Z—(Q)_{y}—Li can be employed, wherein R is a tertiary alkyl or trialkylsilyl group protecting group; and Z, Q and y are the same as defined above. The initiator is used to initiate the polymerization of ethylene, in the presence of an appropriate modifier, i.e., a di- or polydentate complexing agent, followed by acid quenching and removal of the protecting group, resulting in an α-hydroxyl functional polyethylene. Conversion to the terminal olefin functionalized polyethylene is accomplished by an elimination reaction such as acid catalyzed dehydration of the terminal alcohol or a derivative of such. The acid catalysis can be conducted at about 200° C. and higher. The quenching, deprotection, and subsequent dehydration may be carried out separately or simultaneously. Exemplary complexing agents include, but are not limited to, N,N,N′,N′-tetramethylethylenediamine (TMEDA), 1,4-diazabicyclo[2.2.2]octane (DABCO), heterocyclic cryptands, and the like.

Other polyolefin macromonomers with olefin functional terminal groups can be prepared by initiating polymerization of butadiene with a protected hydroxyl functional organolithium initiator as above, then hydrogenating the polymer as described in U.S. Pat. Nos. 4,970,254, 5,166,277, 5,393,843, and 5,496,898, to yield an ethylene-butylene copolymer with an α-protected hydroxyl functional group. Acid quenching of the lithium living end, then acid catalyzed deprotection, followed by an elimination reaction on the terminal alcohol, or a derivative of such, such as acid catalyzed dehydration, yields the ethylene-butylene macromonomer with a terminal olefin group. The deprotection, and subsequent dehydration may be carried out separately or simultaneously.

Similarly, an ethylene-propylene copolymer with olefin functional terminal groups are prepared by initiating polymerization of isoprene with a protected hydroxyl functional organolithium initiator as above, then hydrogenating the polymer as described in U.S. Pat. Nos. 4,970,254, 5,166,277, 5,393,843, and 5,496,898, to yield an ethylene-propylene copolymer with an α-protected hydroxyl functional group. Acid catalyzed deprotection, followed by an elimination reaction on the terminal alcohol, or a derivative of such, such as acid catalyzed dehydration, yields the ethylene-propylene macromonomer with a terminal olefin group. The deprotection, and subsequent dehydration may be carried out separately or simultaneously.

A polystyrene macromonomer with terminal olefin functionality can be similarly prepared as above by polymerization of styrene using a protected hydroxyl functional organolithium initiator, yielding an α-protected hydroxyl functional polystyrene. Quenching of the living lithium chain end, and acid catalyzed deprotection, followed by an elimination reaction on the terminal alcohol, or a derivative of such, such as acid catalyzed dehydration yields the polystyrene macromonomer with a terminal olefin group. The quenching, deprotection, and subsequent dehydration may be carried out separately or simultaneously.

A poly(vinylcyclohexane) macromonomer with terminal olefin functionality can be similarly prepared as above by polymerization of styrene using a protected hydroxyl functional organolithium initiator, yielding an α-protected hydroxyl functional polymer, followed by hydrogenation as described in U.S. Pat. No. 5,352,744 or using a silica supported rhodium catalyst as described in U.S. Pat. Nos. 5,654,253 and 5,700,878. Acid catalyzed deprotection, followed by an elimination reaction on the terminal alcohol, or a derivative of such, such as acid catalyzed dehydration yields the poly(vinyl cyclohexane) macromonomer with a terminal olefin group. The deprotection and subsequent dehydration may be carried out separately or simultaneously.

A poly(vinylcyclohexane-b-ethylene) block copolymer macromonomer with terminal olefin functionality can be prepared using a protected hydroxyl functional initiator to polymerize styrene and ethylene in the presence of TMEDA, yielding a poly(styrene-b-ethylene) copolymer with a protected hydroxyl terminal group. This polymer is then hydrogenated, as described in U.S. Pat. No. 5,352,744 or using a silica supported rhodium catalyst as described in U.S. Pat. Nos. 5,654,253 and 5,700,878. Acid catalyzed deprotection, followed by an elimination reaction on the terminal alcohol, or a derivative of such, such as acid catalyzed dehydration, yields the poly(vinylcyclohexane-b-ethylene) macromonomer with a terminal olefin group. The deprotection and subsequent dehydration may be carried out separately or simultaneously.

α-Olefin, ω-hydroxy-macromonomers analogous to the above polymers can be prepared by use of a protected hydroxyl functional organolithium initiator and carrying out the polymerizations as described above, followed by quenching with an electrophile containing a hydroxyl group with a different protecting group. Following hydrogenation, one of the protecting groups is selectively removed, and an elimination reaction, such as dehydration, carried out on this hydroxyl group, or a derivative of the hydroxyl group. Finally the remaining hydroxyl protecting group is removed, yielding the α-olefin, ω-hydroxy-macromonomer.

α-Olefin, ω-amino-macromonomers analogous to the above polymers may be prepared by use of a protected hydroxyl functional organolithium initiator and carrying out the polymerizations as described above, followed by quenching with an electrophile containing a protected primary or secondary amine group or a tertiary amine group. Following hydrogenation, the hydroxyl protecting group is selectively removed, and an elimination reaction, such as dehydration carried out on this terminal hydroxyl group, or a derivative of the hydroxyl group. Finally the primary or secondary amine protecting group is removed, yielding the α-olefin, ω-amino-macromonomer.

Another type of macromonomer that can be prepared in accordance with the present invention includes a terminal olefin at each end. This can be accomplished by quenching the living anion with ethylene oxide, hydrogenating, deprotecting, then dehydrating. This allows formation of A-B-A graft copolymers, upon subsequent free radical polymerization. In addition, A-B-C graft copolymers can be similarly prepared by dehydration and grafting in sequence.

Thus, by choice of appropriate electrophiles with desired functionalities, other terminal olefin functional macromonomers with these functionalities at the other terminus of the polymer can be prepared in an analogous process to the latter example.

As noted above, polymers can also be prepared in accordance with the present invention which include a ω-protected functionality. In the invention, this protecting group can also be removed, for example, using acid catalysis. If the protecting groups on each end of the polymer are the same, or can be removed the same deprotection procedure, complete deprotection of the polymer can be achieved in a single step. Alternatively, the polymer may include dissimilarly protected terminal functionalities, in which case the one of the protecting groups can be selectively removed without removing the other, using selective reagents specifically suited to remove the targeted protective group, for example, the protecting group —A—R¹R²R³, and to liberate the desired functionality on the end of the polymer chain.

Exemplary reactions in accordance with the invention are illustrated below by Equations 1 and 2:

### Equation 1

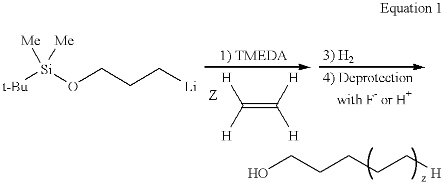

### Equation 2

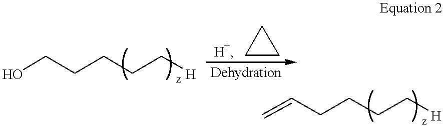

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. Terminal olefin functionalized macromonomers of the formula:
H₂C═CH—Z—(Q)_{y}—poly
wherein:
Z is a C3 to C18 linear, branched or cyclic alkylene radical, optionally containing aryl or substituted aryl groups;
Q is a hydrocarbyl group derived by incorporation of a compound selected from the group consisting of conjugated dienes, alkenylsubstituted aromatic compounds and mixtures thereof;
y is a number greater than 0 to about 5; and
poly comprises a polymer derived from one or more anionically polymerizable monomers.

2. The macromonomer of claim 1, wherein said polymer comprises one or more anionically polymerizable monomers selected from the group consisting of olefin monomers, alkenylsubstituted aromatic monomers, polar monomers and mixtures thereof.

3. The macromonomer of claim 2, wherein said anionically polymerizable monomer comprises one or more olefin monomers.

4. The macromonomer of claim 3, wherein said one or more olefin monomers comprises ethylene.

5. The macromonomer of claim 3, wherein said one or more olefin monomers comprises one or more conjugated diene monomers.

6. The macromonomer of claim 5, wherein said one or more conjugated diene monomers is selected from the group consisting of 1,3-butadiene, isoprene, 2,3-dimethyl-1,3-butadiene, 1,3-pentadiene, myrcene, 2-methyl-3-ethyl-1,3-butadiene, 2-methyl-3-ethyl-1,3-pentadiene, 1,3-hexadiene, 2-methyl-1,3-hexadiene, 1,3-heptadiene, 3-methyl-1,3-heptadiene, 1,3-octadiene, 3-butyl-1,3-octadiene, 3,4-dimethyl-1,3-hexadiene, 3-n-propyl-1,3-pentadiene, 4,5-diethyl-1,3-octadiene, 2,4-diethyl-1,3-butadiene, 2,3-di-n-propyl-1,3-butadiene, 2-methyl-3-isopropyl-1,3-butadiene, and mixtures thereof.

7. The macromonomer of claim 6, wherein said one or conjugated diene monomers comprises butadiene.

8. The macromonomer of claim 6, wherein said one or more conjugated diene monomers comprises isoprene.

9. The macromonomer of claim 5, wherein poly comprises a saturated polymer.

10. The macromonomer of claim 2, wherein said anionically polymerizable monomer comprises one or more alkenylsubstituted aromatic monomers.

11. The macromonomer of claim 10, wherein said one or more alkenylsubstituted aromatic monomers comprises styrene, alpha-methylstyrene, vinyltoluene, 2-vinylpyridine, 4-vinylpyridine, 1-vinylnaphthalene, 2-vinylnaphthalene, 1-alpha-methylvinylnaphthalene, 2-alpha-methylvinylnaphthalene, 1,2-diphenyl-4-methyl-1-hexene, 3-methylstyrene, 3,5-diethylstyrene, 4-tert-butylstyrene, 2-ethyl-4-benzylstyrene, 4-phenylstyrene, 4-p-tolylstyrene, 2,4-divinyltoluene, 4,5-dimethyl-1-vinylnaphthalene, and mixtures thereof.

12. The macromonomer of claim 11, wherein said one or more alkenylsubstituted aromatic monomers comprises styrene.

13. The macromonomer of claim 12, wherein poly is saturated to form a polymer comprising vinylcyclohexane units.

14. The macromonomer of claim 13, wherein poly further comprises ethylene monomer units to form vinylcyclohexane-b-ethylene blocks.

15. The macromonomer of claim 1, wherein poly comprises hydrogen at the end thereof.

16. The macromonomer of claim 1, wherein poly comprises a functional group FG at the end thereof.

17. The macromonomer of claim 16, wherein FG comprises a functional group selected from the group consisting of hydroxyl, thio, amino, carboxyl, amide, silyl, acrylate, sulfonic acid, isocyanate, and epoxide.

18. The macromonomer of claim 16, wherein FG comprises —Y—W—(B—R⁴R⁵R⁶)_{K} wherein:
Y is a C1 to C18 linear, branched or cyclic alkylene radical, optionally containing aryl or substituted aryl groups;
W is oxygen, nitrogen or sulfur;
(B—R⁴R⁵R⁶) is a protecting group in which B is an element selected from Group IVa of the Periodic Table of the Elements; and R⁴, R⁵, and R⁶ are each independently defined as hydrogen, alkyl, substituted alkyl, aryl, substituted aryl, cycloalkyl and substituted cycloalkyl or R⁶ is optionally a —(CR⁷R⁸)ₗ— group linking two B when k is 2, wherein R⁷ and R⁸ are each independently selected from the group consisting of hydrogen, alkyl, substituted alkyl, aryl, substituted aryl, cycloalkyl, and substituted cycloalkyl, and l is an integer from 1 to 7; and
k is 1 when W is oxygen or sulfur and 2 when W is nitrogen.

19. The macromonomer of claim 16, wherein FG comprises —Y—W—(H)_{K} wherein:
W is oxygen, nitrogen or sulfur;
Y is a C1 to C18 linear, branched or cyclic alkylene radical, optionally containing aryl or substituted aryl groups; and
k is 1 when W is oxygen or sulfur and 2 when W is nitrogen.

20. The macromonomer of claim 1, wherein poly comprises an olefin group —CH═CH₂ at the end thereof.

21. The macromonomer of claim 1, wherein poly comprises a polymer segment at the end thereof.

22. A method for making terminal olefin functionalized macromonomers, the method comprising:
anionically polymerizing one or more monomers with one or more protected functionalized initiators of the formula:
(R¹R²R³—A)—O—Z—(Q)_{y}—M,
wherein:
M is an alkali metal;
Z is a C3 to C18 linear, branched or cyclic alkylene radical, optionally containing aryl or substituted aryl groups;
Q is a hydrocarbyl group derived by incorporation of a compound selected from the group consisting of conjugated dienes, alkenylsubstituted aromatic compounds and mixtures thereof;
y is a number greater than 0 to about 5; and
(A—R¹R²R³) is a protecting group in which A is an element selected from Group IVa of the Periodic Table of the Elements; and R¹, R², and R³ are each independently defined as hydrogen, alkyl, substituted alkyl, aryl, substituted aryl, cycloalkyl and substituted cycloalkyl;
to form one or more living polymer anions of the formula (R¹R²R³—A)—O—Z—(Q)_{y}—poly-M;
terminating polymerization to form a polymer of the formula (R¹R²R³—A)—O—Z—(Q)_{y}—poly-FG, wherein FG is hydrogen or a protected or unprotected functional group;
removing the protecting group (R¹R²R³—A)— to liberate the hydroxy functionality to form a polymer of the formula HO—Z—(Q)_{y}—poly-FG; and
treating said deprotected polymer under conditions sufficient to eliminate the hydroxyl group to form a polymer having a terminal olefin group of the formula H₂C═CH—Z—(Q)_{y}—poly-FG.

23. The method of claim 22, wherein said terminating step comprises an acid quenching step.

24. The method of claim 22, wherein said terminating step comprises reacting said living polymer with a functionalizing agent.

25. The method of claim 24, wherein said functionalizing agent is selected from the group consisting of alkylene oxides; oxygen; sulfur; carbon dioxide; halogens; propargyl halides; alkenylhalosilanes; omega-alkenylarylhalosilanes; sulfonated compounds; amides; silicon acetals; 1,5-diazabicyclo[3.1.0]hexane; allyl halides; acryloyl and methacryloyl chloride; amines; epihalohydrins; and haloalkyl trialkoxysilanes.

26. The method of claim 24, wherein said functionalizing agent is an electrophile of the structure:
X—Y—W—(B—R⁴R⁵R⁶)_{K}
wherein:
X is halogen selected from chloride, bromide and iodide;
Y is a C1 to C18 linear, branched or cyclic alkylene radical, optionally containing aryl or substituted aryl groups;
W is oxygen, nitrogen or sulfur;
(B—R⁴R⁵R⁶) is a protecting group in which B is an element selected from Group IVa of the Periodic Table of the Elements; and R⁴, R⁵, and R⁶ are each independently defined as hydrogen, alkyl, substituted alkyl, aryl, substituted aryl, cycloalkyl and substituted cycloalkyl or R⁶ is optionally a —(CR⁷R⁸)ₗ— group linking two B when k is 2, wherein R⁷ and R⁸ are each independently selected from the group consisting of hydrogen, alkyl, substituted alkyl, aryl, substituted aryl, cycloalkyl, and substituted cycloalkyl, and l is an integer from 1 to 7; and
k is 1 when W is oxygen or sulfur and 2 when W is nitrogen.

27. The method of claim 26, further comprising removing the protecting group (B—R⁴R⁵R⁶) to liberate W.

28. The method of claim 27, further comprising reacting said liberated W with one or more comonomers to form a polymer segment.

29. The method of claim 28, wherein said comonomers are selected from the group consisting of cyclic ethers, diamines, diisocyanates, polyisocyanates, di-, poly- and cyclic amides, di- and polycarboxylic acids, diols, polyols, anhydrides, and mixtures thereof.

30. The method of claim 27, further comprising reacting said liberated W with an agent containing a reactive olefinic bond to form an olefinic terminal group.

31. The method of claim 30, wherein said agent is acryoyl or methacryoyl chloride.

32. The method of claim 22, wherein:
said terminating step comprises reacting said living polymer with ethylene oxide; and
said treating step comprises treating said polymer under conditions sufficient to form an α-olefin, ω-olefin macromonomer.

33. The method of claim 22, wherein said polymerization step comprises polymerizing one or more anionically polymerizable monomers selected from the group consisting of olefin monomers, alkenylsubstituted aromatic monomers, polar monomers and mixtures thereof.

34. The method of claim 33, wherein said anionically polymerizable monomer comprises one or more olefin monomers.

35. The method of claim 34, wherein said one or more olefin monomers comprises ethylene.

36. The method of claim 34, wherein said one or more olefin monomers comprises one or more conjugated diene monomers.

37. The method of claim 36, wherein said one or more conjugated diene monomers is selected from the group consisting of 1,3-butadiene, isoprene, 2,3-dimethyl-1,3-butadiene, 1,3-pentadiene, myrcene, 2-methyl-3-ethyl-1,3-butadiene, 2-methyl-3-ethyl-1,3-pentadiene, 1,3-hexadiene, 2-methyl-1,3-hexadiene, 1,3-heptadiene, 3-methyl-1,3-heptadiene, 1,3-octadiene, 3-butyl-1,3-octadiene, 3,4-dimethyl-1,3-hexadiene, 3-n-propyl-1,3-pentadiene, 4,5-diethyl-1,3-octadiene, 2,4-diethyl-1,3-butadiene, 2,3-di-n-propyl-1,3-butadiene, 2-methyl-3-isopropyl-1,3-butadiene, and mixtures thereof.

38. The method of claim 37, wherein said one or conjugated diene monomers comprises butadiene.

39. The method of claim 37, wherein said one or more conjugated diene monomers comprises isoprene.

40. The method of claim 36, further comprising hydrogenating said polymer.

41. The method of claim 33, wherein said anionically polymerizable monomer comprises one or more alkenylsubstituted aromatic monomers.

42. The method of claim 41, wherein said one or more alkenylsubstituted aromatic monomers comprises styrene, alpha-methylstyrene, vinyltoluene, 2-vinylpyridine, 4-vinylpyridine, 1-vinylnaphthalene, 2-vinylnaphthalene, 1-alpha-methylvinylnaphthalene, 2-alpha-methylvinylnaphthalene, 1,2-diphenyl-4-methyl-1-hexene, 3-methylstyrene, 3,5-diethylstyrene, 4-tert-butylstyrene, 2-ethyl-4-benzylstyrene, 4-phenylstyrene, 4-p-tolylstyrene, 2,4-divinyltoluene, 4,5-dimethyl-1-vinylnaphthalene, and mixtures thereof.

43. The method of claim 42, wherein said one or more alkenylsubstituted aromatic monomers comprises styrene.

44. The method of claim 42, further comprising hydrogenating said polymer to form a polymer comprising vinylcyclohexane units.

45. The method of claim 44, wherein said polymerization step comprises copolymerizing styrene and ethylene to form vinylcyclohexane-b-ethylene blocks.

46. A method for making terminal olefin functionalized macromonomers, the methods comprising:
anionically polymerizing one or more monomers with at least one protected functionalized initiator of the formula:
(R¹R²R³—A)₂—N—Z—(Q)_{y}—M,
or 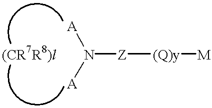
wherein:
M is an alkali metal;
Z is a C3 to C18 linear, branched or cyclic alkylene radical, optionally containing aryl or substituted aryl groups;
Q is a hydrocarbyl group derived by incorporation of a compound selected from the group consisting of conjugated dienes, alkenylsubstituted aromatic compounds and mixtures thereof;
y is a number greater than 0 to about 5; and
(A—R¹R²R³) and 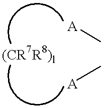
are protecting groups in which each A is independently an element selected from Group IVa of the Periodic Table of the Elements; R¹, R², R³, R⁷ and R⁸ are each independently defined as hydrogen, alkyl, substituted alkyl, aryl, substituted aryl, cycloalkyl and substituted cycloalkyl; and l is an integer from 1 to 7; to form at least one living polymer anion of the formula
(R¹R²R³—A)₂—N—Z—(Q)_{y}—poly-M
or 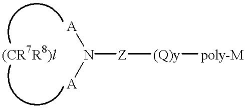
terminating polymerization to form at least one polymer of the formula (R¹R²R³—A)₂—N—Z—(Q)_{y}—poly-FG or 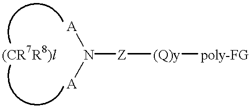
wherein FG is hydrogen or a protected or unprotected functional group;
treating said protected tertiary amine group under conditions sufficient to provide a modified amine group capable of elimination; and
treating said polymer under conditions sufficient to eliminate the modified amine group to form a polymer having a terminal olefin group of the formula H₂C═CH—Z—(Q)_{y}—poly-FG.

47. The method of claim 46, wherein said terminating step comprises an acid quenching step.

48. The method of claim 46, wherein said terminating step comprises reacting said living polymer with a functionalizing agent.

49. The method of claim 48, wherein said functionalizing agent is selected from the group consisting of alkylene oxides; oxygen; sulfur; carbon dioxide; halogens; propargyl halides; alkenylhalosilanes; omega-alkenylarylhalosilanes; sulfonated compounds; amides; silicon acetals; 1,5-diazabicyclo[3.1.0]hexane; allyl halides; acryloyl and methacryloyl chloride; amines; epihalohydrins; and haloalkyl trialkoxysilanes.

50. The method of claim 48, wherein said functionalizing agent is an electrophile of the structure:
X—Y—W—(B—R⁴R⁵R⁶)_{K}
wherein:
X is halogen selected from chloride, bromide and iodide;
Y is a C1 to C18 linear, branched or cyclic alkylene radical, optionally containing aryl or substituted aryl groups;
W is oxygen, nitrogen or sulfur;
(B—R⁴R⁵R⁶) is a protecting group in which B is an element selected from Group IVa of the Periodic Table of the Elements; and R⁴, R⁵, and R⁶ are each independently defined as hydrogen, alkyl, substituted alkyl, aryl, substituted aryl, cycloalkyl and substituted cycloalkyl or R⁶ is optionally a —(CR⁷R⁸)ₗ— group linking two B when k is 2, wherein R⁷ and R⁸ are each independently selected from the group consisting of hydrogen, alkyl, substituted alkyl, aryl, substituted aryl, cycloalkyl, and substituted cycloalkyl, and l is an integer from 1 to 7; and
k is 1 when W is oxygen or sulfur and 2 when W is nitrogen.

51. The method of claim 50, further comprising removing the protecting group (B—R⁴R⁵R⁶) to liberate W.

52. The method of claim 51, further comprising reacting said liberated W with one or more comonomers to form a polymer segment.

53. The method of claim 52, wherein said comonomers are selected from the group consisting of cyclic ethers, diamines, diisocyanates, polyisocyanates, di-, poly- and cyclic amides, di- and polycarboxylic acids, diols, polyols, anhydrides, and mixtures thereof.

54. The method of claim 51, further comprising reacting said liberated W with an agent containing a reactive olefinic bond to form a olefinic terminal group.

55. The method of claim 54, wherein said agent is acryoyl or methacryoyl chloride.

56. The method of claim 46, wherein:
said terminating step comprises reacting said living polymer with ethylene oxide; and
said treating step comprises treating said polymer under conditions sufficient to form an α-olefin, ω-olefin macromonomer.

57. The method of claim 46, wherein said polymerization step comprises polymerizing one or more anionically polymerizable monomers selected from the group consisting of olefin monomers, alkenylsubstituted aromatic monomers, polar monomers and mixtures thereof.

58. The method of claim 57, wherein said anionically polymerizable monomer comprises one or more olefin monomers.

59. The method of claim 58, wherein said one or more olefin monomers comprises ethylene.

60. The method of claim 58, wherein said one or more olefin monomers comprises one or more conjugated diene monomers.

61. The method of claim 60, wherein said one or more conjugated diene monomers is selected from the group consisting of 1,3-butadiene, isoprene, 2,3-dimethyl-1,3-butadiene, 1,3-pentadiene, myrcene, 2-methyl-3-ethyl-1,3-butadiene, 2-methyl-3-ethyl-1,3-pentadiene, 1,3-hexadiene, 2-methyl-1,3-hexadiene, 1,3-heptadiene, 3-methyl-1,3-heptadiene, 1,3-octadiene, 3-butyl-1,3-octadiene, 3,4-dimethyl-1,3-hexadiene, 3-n-propyl-1,3-pentadiene, 4,5-diethyl-1,3-octadiene, 2,4-diethyl-1,3-butadiene, 2,3-di-n-propyl-1,3-butadiene, 2-methyl-3-isopropyl-1,3-butadiene, and mixtures thereof.

62. The method of claim 61, wherein said one or conjugated diene monomers comprises butadiene.

63. The method of claim 61, wherein said one or more conjugated diene monomers comprises isoprene.

64. The method of claim 60, further comprising hydrogenating said polymer.

65. The method of claim 57, wherein said anionically polymerizable monomer comprises one or more alkenylsubstituted aromatic monomers.

66. The method of claim 65, wherein said one or more alkenylsubstituted aromatic monomers comprises styrene, alpha-methylstyrene, vinyltoluene, 2-vinylpyridine, 4-vinylpyridine, 1-vinylnaphthalene, 2-vinylnaphthalene, 1-alpha-methylvinylnaphthalene, 2-alpha-methylvinylnaphthalene, 1,2-diphenyl-4-methyl-1-hexene, 3-methylstyrene, 3,5-diethylstyrene, 4-tert-butylstyrene, 2-ethyl-4-benzylstyrene, 4-phenylstyrene, 4-p-tolylstyrene, 2,4-divinyltoluene, 4,5-dimethyl-1-vinylnaphthalene, and mixtures thereof.

67. The method of claim 66, wherein said one or more alkenylsubstituted aromatic monomers comprises styrene.

68. The method of claim 67, further comprising hydrogenating said polymer to form a polymer comprising vinylcyclohexane units.

69. The method of claim 68, wherein said polymerization step comprises copolymerizing styrene and ethylene to form vinylcyclohexane-b-ethylene blocks.

70. The method of claim 46, wherein treating said protected tertiary amine to provide a modified amine group capable of elimination comprises reacting said protected tertiary amine group with a quaternizing agent to form a quaternary amine group.

71. The method of claim 70, wherein treating said polymer to eliminate said modified amine group comprises heating said polymer.

72. The method of claim 46, wherein treating said protected tertiary amine to provide a modified amine group capable of elimination comprises reacting said protected tertiary amine group with a peroxide or peracid to form an N-oxide group.

73. The method claim 72, wherein treating said polymer to eliminate said modified amine group comprises heating said polymer.

74. The method of claim 22, wherein said treating step to eliminate the hydroxyl group to form a polymer having a terminal olefin group comprises dehydrating said polymer using a hydroxyl dehydrating agent.

75. The method of claim 74, wherein said hydroxyl dehydrating agent is selected from the group consisting of H₂SO₄, H₃PO₄, metallic oxides, sulfides, metallic salts, zeolites, P₂O₅, I₂, ZnCl₂, BF₃-etherate, dimethyl sulfoxide, KHSO₄, and phthalic anhydride.

76. The method of claim 74, wherein said dehydrating agent is an acid dehydrating agent.

77. The method of claim 76, wherein said acid dehydrating agent is H₂SO₄

78. The method of claim 76, wherein said acid dehydrating agent is H₃PO₄.

79. The method of claim 74, wherein said treating step is conducted at a temperature of at least about 100° C.
